(19) United States
(12) Patent Application Publication
(10) Pub. No.: US 2019/0152061 A1
(43) Pub. Date: May 23, 2019

(54) MOTION CONTROL METHOD AND DEVICE, AND ROBOT WITH ENHANCED MOTION CONTROL

(71) Applicant: UBTECH Robotics Corp, Shenzhen (CN)

(72) Inventors: Youjun Xiong, Shenzhen (CN); Yizhang Liu, Shenzhen (CN); Ligang Ge, Shenzhen (CN); Chunyu Chen, Shenzhen (CN)

(21) Appl. No.: 16/161,077

(22) Filed: Oct. 16, 2018

(30) Foreign Application Priority Data
Nov. 21, 2017 (CN) 201711166772.2

(51) Int. Cl. B25J 9/16; G10H 1/00

(52) U.S. Cl. CPC B25J 9/1694; G10H 1/0008; G10L 19/00; G10H 2210/066; B25J 9/1628

(57) ABSTRACT

The present disclosure relates to a motion control method and device for a robot, and a robot with enhanced motion control. The method includes: receiving audio information by an audio receiver of the audio processing device in response to a key of an instrument being pressed, wherein the instrument is disposed within a default distance from the audio receiver; decoding the audio information and transforming the audio information into audio signals hs an audio decoder of the audio processing device; determining an expected movement of at least one joint of the robot according to a sound-freedom mapping table, and generating an adjustment message; receiving Joint-location information of the joint of the robot at a current moment; and driving the joint of the robot by the servo according to the adjustment message and the joint-location information.

### CROSS REFERENCE TO RELATED APPLICATIONS

This application claims priority to Chinese Patent Application No. CN201711166772.2, filed Nov. 21, 2017 which is hereby incorporated by reference herein as if set forth in its entirety.

### BACKGROUND

### 1. Technical Field

The present disclosure relates to intelligent control technology, and particularly to a motion control method and device for a robot, and a robot with enhanced motion control.

### 2. Description of Related Art

With the technology development, robots have been widely adopted in people's lives, such as a sweeping robot, a dancing robot, and the like. It is inevitable for a robot to interact with people or objects around it. For example, when the dancing robot is dancing, it is expected that the robot may move according to the rhythm of the music. At present, the interaction methods of robots mainly include drag teaching, bone extraction, speech recognition, etc. These methods have high requirements on the performance of the robot and the algorithms in the control process, and it is also difficult to realize the robot with rhythm. Conventionally, the programming process of writing and storing tracks in a robot is cumbersome, and it takes a lot of time and effort to complete such process.

### BRIEF DESCRIPTION OF THE DRAWINGS

To describe the technical schemes in the embodiments of the present disclosure more clearly, the following briefly introduces the drawings required for describing the embodiments or the prior art. Apparently, the drawings in the following description merely show some examples of the present disclosure. For those skilled in the art, other drawings can be obtained according to the drawings without creative efforts.

FIG. 1 is a schematic diagram of a robot with enhanced motion control and an motion control device in accordance with one embodiment of the present disclosure.

FIG. 2 is a flow chart of a motion control method of a robot in accordance with one embodiment of the present disclosure.

FIG. 3 is an example of the motion control method in FIG. 2.

### DETAILED DESCRIPTION

In the following descriptions, for purposes of explanation instead of limitation, specific details such as particular system architecture and technique are set forth in order to provide a thorough understanding of embodiments of the present disclosure. However, it will be apparent to those skilled in the art that the present disclosure may be implemented in other embodiments that are less specific of these details. In other instances, detailed descriptions of well-known systems, devices, circuits, and methods are omitted so as not to obscure the description of the present disclosure with unnecessary detail.

It is to be understood that, when used in the description and the appended claims of the present disclosure, the terms “including” and “comprising” indicate the presence of stated features, integers, steps, operations, elements and/or components, but do not preclude the presence or addition of one or a plurality of other features, integers, steps, operations, elements, components and/or combinations thereof.

It is also to be understood that, the terminology used in the description of the present disclosure is only for the purpose of describing particular embodiments and is not intended to limit the present disclosure. As used in the description and the appended claims of the present disclosure, the singular forms “a,” “an,” and “the” are intended to include the plural forms as well, unless the context clearly indicates otherwise.

It is also to be further understood that the term “and/or” used in the description and the appended claims of the present disclosure refers to any combination of one or more of the associated listed items and all possible combinations, and includes such combinations.

For the purpose of describing the technical solutions of the present disclosure, the following describes through specific embodiments.

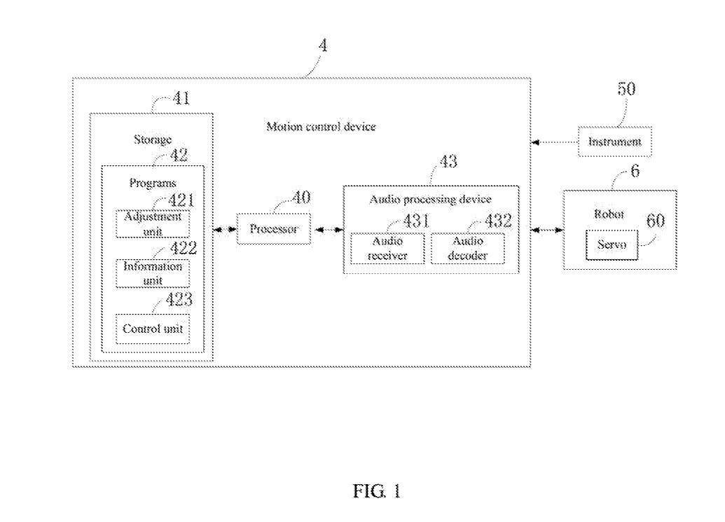

FIG. 1 is a schematic diagram of a robot with enhanced motion (“robot 6”) and a motion control device 4 in accordance with one embodiment of the present disclosure.

For the convenience of description, only the parts related to this embodiment are shown. As shown in FIG. 1, in this embodiment, the motion control device 4 includes a processor 40, a storage 41, computer programs 42 stored in the storage 41 (e.g., a memory) and executable on the processor 40, for example, a Linux program, and an audio processing device 43. The storage 41, and the audio processing device 43 electrically connect to the processor 40. In addition, the robot 6 includes at least a servo 60. In an example, the motion control device 4 is configured within the robot 6, and the servo 60 is controlled by the processor 40. In another example, the motion control device 4 connects to the servo 60 of the robot 6 via a wireless connection, such that the servo 60 of the robot 6 is controlled by the motion control device 4. That is, the motion control device 4 can be included as part of the robot 6 as an internal component or be an external component to the robot 6 as an external computing device, such as a mobile phone, a tablet, etc.

Exemplarily, the computer programs 42 may be divided into one or more modules/units, and the one or more modules/units are stored in the storage 41 and executed by the processor 40 to realize the present disclosure. The one or more modules/units may be a series of computer program instruction sections capable of performing a specific function, and the instruction sections are for describing the execution process of the computer programs 42 in the motion control device 4.

It can be understood by those skilled in the art that FIG. 1 is merely an example of the robot 6 and the motion control device 4 and does not constitute a limitation on the robot 6 and the motion control device 4, and may include more or fewer components than those shown in the figure, or a combination of some components or different components. For example, the robot 6 and the motion control device 4 may further include a processor, a storage, an input/output device, a network access device, a bus, and the like.

The processor 40 may be a central processing unit (CPU), or be other general purpose processor, a digital signal processor (DSP), application specific integrated circuit (ASIC), a field-programmable gate array (FPGA), or be other programmable logic device, a discrete gate, a transistor logic device, and a discrete hardware component. The general purpose processor may be a microprocessor, or the processor may also be any conventional processor.

The storage 41 may be an internal storage unit of the motion control device 4, for example, a hard disk or a memory of the motion control device 4. The storage 41 may also be an external storage device of the motion control device 4, for example, a plug-in hard disk, a smart media card (SMC), a secure digital (SD) card, flash card, and the like, which is equipped on motion control device 4. Furthermore, the storage 41 may further include both an internal storage unit and an external storage device, of the motion control device 4. The storage 41 is configured to store the computer program and other programs and data required by the motion control device 4. The storage 41 may also be used to temporarily store data that has been or will be output.

In an example, the motion control device 4 includes an adjustment unit 421, an information unit 422, and a control unit 423. When the processor 40 executes the computer programs 42, the functions of the units 421-423 as shown in FIG. 1, are implemented.

In an example, the audio processing device 43 includes, at least, an audio receiver 431 and an audio decoder 432. The audio receiver 431 is configured to receive the audio information generated when an instrument 50 within a default distance is played, wherein the audio information may include at least one of a tone, a scale or a duration. In an example, the instrument 50 may he a piano. The audio receiver 431 is configured to receive the audio information from the piano when a key of the piano is pressed.

In the embodiment, the sound information of the instrument 50 is collected by the audio receiver 431. It can be understood that the audio receiver 431 may be configured along with the audio processing device 43, or the audio receiver 431 may be physically independently from the audio processing device 43.

In order to precisely receive the sound information from the instrument, the instrument 50 is disposed within a default distance from the audio receiver 431.

In an example, the audio processing device 43 may also configured to detect a status of the instrument. For instance, the audio receiver 431 is configured to detect whether a key of the piano is pressed, a pressed degree of the key, and a duration of the press.

The audio decoder 432 is configured to decode the audio information received by the audio receiver 431 and to transform the audio information into audio signals.

The adjustment unit 421 is configured to receive the audio signals from the audio decoder 432, to determine an expected movement of at least one joint of the robot according to a sound-freedom mapping table stored in the storage, and to generate an adjustment message according to the audio signals and the expected movement.

In an example, the sound-freedom mapping table is configured according to sound characteristics of each instrument 50 and the corresponding freedom degree. When the information unit 422 receives the sound signals from the audio decoder 432, the information unit 422 determines die expected movement of the joint of the robot 6 accordingly. In an example, the movement is directed to an angle change and speed of the joint.

In an example, the adjustment message may include a freedom degree with respect to a single joint or a combination of the freedom degree with respect to a plurality of joints. In an example, for a biped robot, the body contains 6 degrees of freedom, and the adjustment message may include the six degrees of freedom or the linear/nonlinear combination of the six degrees of freedom.

The information unit 422 is configured to receive joint-location information of the joint of the robot at a current moment.

The control unit 423 is configured to drive the joint of the robot 6 by a servo 60 according to the adjustment message and the joint-location information.

In an embodiment, the control unit 423 is further configured to:

determine an angle adjustment and a speed adjustment of the joint by calculating the freedom degree of the joint at each moment;

generate a corresponding orbit of the joint; and

drive the joint of the robot 6 by the servo 60 according to the orbit of the joint.

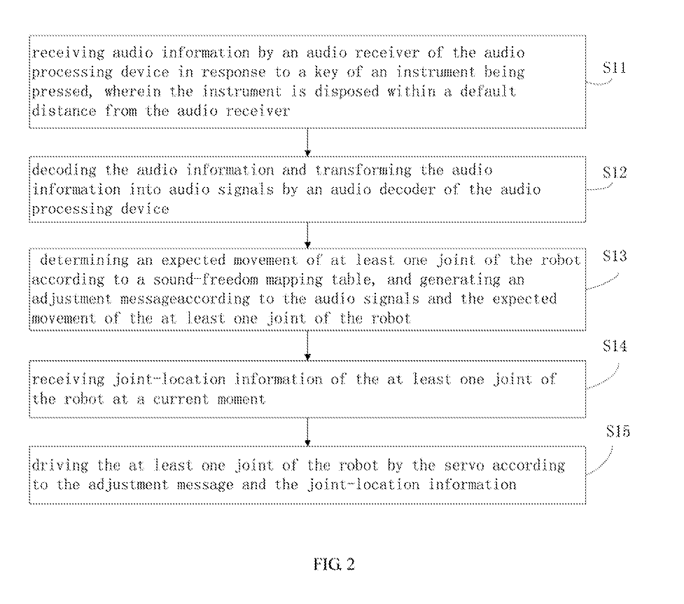

FIG. 2 is a flow chart of a motion control method of a robot in accordance with one embodiment of the present disclosure. In this embodiment, the method is a computer-implemented method executable for a processor 40. As shown in FIG. 2, the method includes the following steps.

In step S11, receiving the audio information by an audio receiver 431, the audio information being generated when an instrument 50 within a default distance is played, wherein the audio information may include at least one of a tone, a scale or a duration.

In step S12, decoding the audio information received from the audio receiver 431 and transforming the audio information into audio signals by an audio decoder 432.

In step S13, receiving the audio signals from the audio decoder 432, determining an expected movement of at least one joint of the robot 6 according to a sound-freedom mapping table, and generating an adjustment message according to the audio signals and the expected movement of at least one joint of the robot 6.

In an example, the sound-freedom mapping table is configured according to sound characteristics of each instrument 50 and the corresponding freedom degree. When the information unit 422 receives the sound signals from the audio decoder 432, the information unit 422 determines the expected movement of the joint of the robot 6. In an example, the movement is directed to an angle change.

In step S14, receiving joint-location information of the joint of the robot 6 at a current moment.

In an example, the joint-location information may include a position or a posture of a main body of the robot 6, or the position or the posture of the joint of the robot 6.

In step S15, driving the joint of the robot 6 by a servo 60 according to the adjustment message and the joint-location information.

In view of the above, the movement of the robot 6 may be easily controlled in response to sound information generated by the instrument 50, and the musical tracks have not to be written/stored in advance.

It should be understood that, the sequence of the serial number of the steps in the above-mentioned embodiments does not represent the execution order. The order of the execution of each process should be determined by its function and internal logic, and should not cause a limitation to the implementation process of the embodiments of the present disclosure.

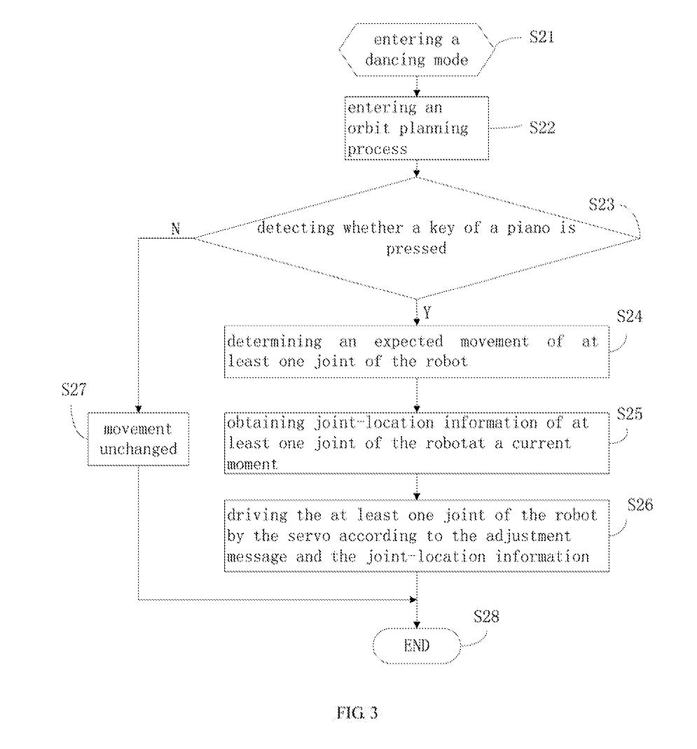

FIG. 3 is an example of the motion control method in FIG. 2.

In step S21, entering a dancing mode;

In step S22, entering an orbit planning process;

In step S23, detecting whether a key of a piano is pressed. If the key of the piano is pressed, the process goes to step S24. If the key of the piano is not pressed, the process goes to step S27.

In step S24, determining an expected movement of the joint of the robot;

In step S25, obtaining joint-location information at a current moment;

In step S26, driving the robot according to the adjustment message and the joint-location information;

In step S28, the process ends.

In step S23, the process goes to step S27 in response to the key of the piano has not been pressed.

In step S27, the movement of the robot remains the same.

Optionally, since the piano includes a plurality of sound zones, such as a subwoofer, a bass, a bass, a midrange, a treble, a high pitch, and an ultra-high range. Each of the sound zones includes at least one set of syllables, and each syllable includes 7 sounds. The 7 tones of the preset midrange correspond to the 7 basic movements of the robot, and the different zones can change the frequency and amplitude of the corresponding action in 7 basic actions, thereby deriving more actions. When the piano is played, the robot can automatically make a dance action according to the music rhythm from different pianos.

Those skilled in the art may clearly understand that, for the convenience and simplicity of description, the division of the above-mentioned functional units and modules is merely an example for illustration. In actual applications, the above-mentioned functions may be allocated to be performed by different functional units according to requirements, that is, the internal structure of the device may be divided into different functional units or modules to complete all or part of the above-mentioned functions. The functional units and modules in the embodiments may he integrated in one processing unit, or each unit may exist alone physically, or two or more units may be integrated in one unit. The above-mentioned integrated unit may be implemented in the form of hardware or in the form of software functional unit. In addition, the specific name of each functional unit and module is merely for the convenience of distinguishing each other and are not intended to limit the scope of protection of the present disclosure. For the specific operation process of the units and modules in the above-mentioned system, reference may be made to the corresponding processes in the above-mentioned method embodiments, and are not described herein.

Those skilled in the art may clearly understand that, for the convenience and simplicity of description, the division of the above-mentioned functional units and modules is merely an example for illustration. In actual applications, the above-mentioned functions may be allocated to be performed by different functional units according to requirements, that is, the internal structure of the device may be divided into different functional units or modules to complete all or part of the above-mentioned functions. The functional units and modules in the embodiments may be integrated in one processing unit, or each unit may exist alone physically, or two or more units may be integrated in one unit. The above-mentioned integrated unit may be implemented in the form of hardware or in the form of software functional unit. In addition, the specific name of each functional unit and module is merely for the convenience of distinguishing each other and are not intended to limit the scope of protection of the present disclosure. For the specific operation process of the units and modules in the above-mentioned system, reference may be made to the corresponding processes in the above-mentioned method embodiments, and are not described herein.

In the above-mentioned embodiments, the description of each embodiment has its focuses, and the parts which are not described or mentioned in one embodiment may refer to the related descriptions in other embodiments.

Those ordinary skilled in the art may clearly understand that, the exemplificative units and steps described in the embodiments disclosed herein may be implemented through electronic hardware or a combination of computer software and electronic hardware. Whether these functions are implemented through hardware or software depends on the specific application and design constraints of the technical schemes. Those ordinary skilled in the art may implement the described functions in different manners for each particular application, while such implementation should not be considered as beyond the scope of the present disclosure.

In the embodiments provided by the present disclosure, it should be understood that the disclosed apparatus (device)/terminal device and method may be implemented in other manners. For example, the above-mentioned apparatus (device)/terminal device embodiment is merely exemplary. For example, the division of modules or units is merely a logical functional division, and other division manner may be used in actual implementations, that is, multiple units or components may be combined or be integrated into another system, or some of the features may be ignored or not performed. In addition, the shown or discussed mutual coupling may be direct coupling or communication connection, and may also be indirect coupling or communication connection through some interfaces, devices or units, and may also be electrical, mechanical or other forms.

The units described as separate components may or may not be physically separated. The components represented as units may or may not be physical units, that is, may be located in one place or be distributed to multiple network units. Some or all of the units may be selected according to actual needs to achieve the objectives of this embodiment.

In addition, each functional unit in each of the embodiments of the present disclosure may be integrated into one processing unit, or each unit may exist alone physically, or two or more units may be integrated in one unit. The above-mentioned integrated unit may be implemented in the form of hardware or in the form of software functional unit.

When the integrated module/unit is implemented in the form of a software functional unit and is sold or used as an independent product, the integrated module/unit may be stored in a non-transitory computer-readable storage medium. Based on this understanding, all or part of the processes in the method for implementing the above-mentioned embodiments of the present disclosure may also be implemented by instructing relevant hardware through a computer program. The computer program may be stored in a non-transitory computer-readable storage medium, which may implement the steps of each of the above-mentioned method embodiments when executed by a processor. In which, the computer program includes computer program codes which may be the form of source codes, object codes, executable files, certain intermediate, and the like. The computer-readable medium may include any primitive or device capable of carrying the computer program codes, a recording medium, a USB flash drive, a portable hard disk, a magnetic disk, an optical disk, a computer memory, a read-only memory (ROM), a random access memory (RAM), electric carrier signals, telecommunication signals and software distribution media. It should be noted that the content contained in the computer readable medium may be appropriately increased or decreased according to the requirements of legislation and patent practice in the jurisdiction. For example, in some jurisdictions, according to the legislation and patent practice, a computer readable medium does not include electric carrier signals and telecommunication signals.

The above-mentioned embodiments are merely intended for describing but not for limiting the technical schemes of the present disclosure. Although the present disclosure is described in detail with reference to the above-mentioned embodiments, it should be understood by those skilled in the art that, the technical schemes in each of the above-mentioned embodiments may still be modified, or some of the technical features may be equivalently replaced, while these modifications or replacements do not make the essence of the corresponding technical schemes depart from the spirit and scope of the technical schemes of each of the embodiments of the present disclosure, and should be included within the scope of the present disclosure.

What is claimed is:

1. A computer-implemented method for motion control of a robot with a servo, wherein a motion control device electrically connects to the servo, the motion control device comprises an audio processing device, the method comprising executing on a processor steps of:
receiving audio information by an audio receiver of the audio processing device in response to a key of an instrument being pressed, wherein the instrument is disposed within a default distance from the audio receiver;
decoding the audio information and transforming the audio information into audio signals by an audio decoder of the audio processing device;
determining an expected movement of at least one joint of the robot according to a sound-freedom mapping table;
generating an adjustment message according to the audio signals and the expected movement of the at least one joint of the robot;
receiving joint-location information of the at least one joint of the robot at a current moment; and
driving the at least one joint of the robot by the servo according to the adjustment message and the joint-location information.

2. The method as claimed in claim 1, wherein the expected movement of the at least one joint comprises an angle change and a speed change of the at least one joint, and the adjustment message comprises a freedom degree with respect to a single joint or a combination of the freedom degrees with respect to a plurality of joints.

3. The method as claimed in claim 2, wherein driving step comprises:
determining an angle adjustment and a speed adjustment of the at least one joint by calculating the freedom degree of the at least one joint at each moment;
generating a corresponding orbit of the at least one joint; and
driving the at least one joint of the robot by the servo according to the orbit of the at least one joint.

4. The method as claimed in claim 2, wherein the audio information comprises at least one of a tone, a scale or a duration.

5. The method as claimed in claim 2, wherein step of receiving the audio information comprises:
detecting a status of the instrument by the audio processing device.

6. The method as claimed in claim 2, wherein the sound-freedom mapping table is configured according to sound characteristics of the instrument and the corresponding freedom degree of the robot.

7. A computing device for motion control of a robot with a servo, the device electrically connects to servo of the robot, the device comprising:
one or more processors;
an audio processing device electrically connected to the one or more processors;
a storage, wherein computerized instructions are stored in the storage and configured to executed a method, the method comprises:
receiving audio information by an audio receiver of the audio processing device in response to a key of an instrument being pressed, wherein the instrument is disposed within a default distance from the audio receiver;
decoding the audio information and transforming the audio information into audio signals by an audio decoder of the audio processing device;
determining an expected movement of at least one joint of the robot according to a sound-freedom mapping table, and generating an adjustment message according to the audio signals and the expected movement of the at least one joint of the robot;
receiving joint-location information of the at least one joint of the robot at a current moment; and
driving the at least one joint of the robot by the servo according to the adjustment message and the joint-location information.

8. The device as claimed in claim 7, wherein the expected movement of the at least one joint comprises an angle change and a speed change of the at least one joint, and the adjustment message comprises a freedom degree with respect to a single joint or a combination of the freedom degrees with respect to a plurality of joints.

9. The device as claimed in claim 8, wherein driving step comprises:
determining an angle adjustment and a speed adjustment of the at least one joint by calculating the freedom degree of the at least one joint at each moment;
generating a corresponding orbit of the at least one joint; and
driving the at least one joint of the robot by the servo according to the orbit of the at least one joint.

10. The device as claimed in claim 8, wherein the audio information comprises at least one of a tone, a scale or a duration.

11. The device as claimed in claim 8, wherein step of receiving the audio information comprises:
detecting a status of the instrument by the audio processing device.

12. The device as claimed in claim 8, wherein the sound-freedom mapping table is configured according to sound characteristics of the instrument and the corresponding freedom degree of the robot.

13. A robot with enhanced motion control, comprising:
a servo; and
a motion control device electrically connects to the servo;
the motion control device comprising one or more processors, and an audio processing device, and a storage, and one or more computer programs, wherein the one or more computer programs are stored on the storage and configured to be executed by the one or more processors, the one or more computer programs comprising:
instructions for receiving audio information by an audio receiver of the audio processing device in response to a key of an instrument being pressed, wherein the instrument is disposed within a default distance from the audio receiver;
instructions for decoding the audio information and transforming the audio information into audio signals by an audio decoder of the audio processing device;
instructions for determining an expected movement of at least one joint of the robot according to a sound-freedom mapping table;
generating an adjustment message according to the audio signals and the expected movement of the at least one joint of the robot;
instructions for receiving joint-location information of the at least one joint of the robot at a current moment; and
instructions for driving the at least one joint of the robot by the servo according to the adjustment message and the joint-location information.

14. The robot as claimed in claim 13, wherein the expected movement of the at least one joint comprises an angle change and a speed change of the at least one joint, and the adjustment message comprises a freedom degree with respect to a single joint or a combination of the freedom degrees with respect to a plurality of joints.

15. The robot as claimed in claim 14, wherein the instructions for driving the at least one joint of the robot comprises:
determining an angle adjustment and a speed adjustment of the at least one joint by calculating the freedom degree of the at least one joint at each moment;
generating a corresponding orbit of the at least one joint; and
driving the at least one joint of the robot by the servo according to the orbit of the at least one joint.

16. The robot as claimed in claim 14, wherein the audio information comprises at least one of a tone, a scale or a duration.

17. The robot as claimed in claim 14, wherein the instructions for receiving the audio information comprises:
detecting a status of the instrument by the audio processing device.

18. The robot as claimed in claim 14, wherein the sound-freedom mapping table is configured according to sound characteristics of the instrument and the corresponding freedom degree of the robot.
